(19) United States
(12) Patent Application Publication
(10) Pub. No.: US 2003/0049409 A1
(43) Pub. Date: Mar. 13, 2003

(54) Use of a high density paper support as a support strip in a cover material for an adhesive tape

(76) Inventor: Andreas Wieck, Halstenbek (DE)

Correspondence Address: Kurt G Briscoe, Norris McLaughlin & Marcus, 30th Floor, 220 East 42nd Street, New York, NY, 10017, US

(21) Appl. No.: 10/239,257

(22) PCT Filed: May 17, 2001
(86) PCT No.: PCT/EP01/05654

(51) Int. Cl. B32B 3/10

(52) U.S. Cl. 428/136

(57) ABSTRACT

The use of a paper carrier having a density of from 1.1 to 1.25 g/cm³ as a carrier web in a lining material for an adhesive tape, the paper carrier essentially having a top side and a bottom side, the paper carrier being provided with a polymer coating on the top side and/or on the bottom side, and an antiadhesive layer having been applied to at least one of the two possible polymer coatings.

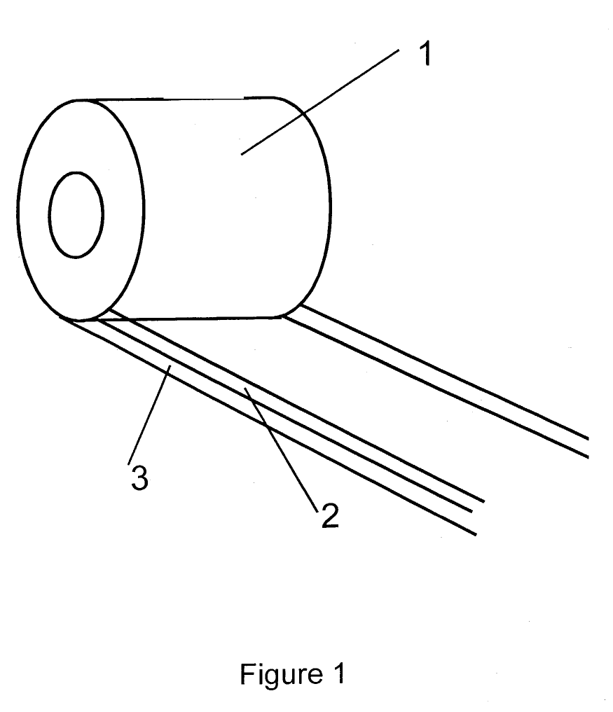

The invention relates to the use of a high density paper carrier as the carrier web in a lining material for an adhesive tape, to a lining material with diecuts, and to the use of the lining material with diecuts.

Depending on the particular application, parts which are to be fastened by means of a double sided adhesive tape (for example, electronic components or seals in mobile telephones) require the use of double sidedly adhering punched parts. These punched parts must be converted to the required form beforehand in a die-cutting operation, particularly in an operation referred to as kiss-cutting, in which case the adhesive tape for producing the punched parts needs to be lined beforehand with an antiadhesive material.

A feature of the kiss-cut process is that, in the course of die-cutting, the antiadhesive material is not injured or cut, or not substantially injured or cut. This prevents the situation in which, following die-cutting, adhesive from the punched parts runs into the incisions and sticks to the material. Were this to occur, it could give rise, in downstream production steps where the material is to be processed with the punched parts, to splitting of the material. The entire roll would then be excluded from further processing and would therefore be waste.

Particularly suitable antiadhesive material comprises antiadhesive release paper, based for example on paper structures with different degrees of densification (and also release films based on PET, PP, PE).

Particularly for paper-based antiadhesive materials, stringent requirements are imposed in the converting operation on the thickness of the material, the consistency of thickness (low tolerances), and the flatness (dimensional stability).

Antiadhesive glassine papers referred to as highly densified, such as are commonly used, are of only limited usefulness owing to deficient flatness properties, especially under extreme climatic conditions.

It is an object of the invention to provide a paper carrier whose flatness properties and consistency of thickness make it suitable for the converting operation of adhesive diecuts.

This object is achieved through the use of a paper carrier as a carrier web in a lining material for an adhesive tape, as specified in the main claim. The subclaims relate to advantageous developments of the subject matter of-the invention and also to particularly advantageous uses thereof.

The invention accordingly provides for the use of a paper carrier having a density of from 1.1 to 1.25 g/cm³ as a carrier web in a lining material for an adhesive tape, the paper carrier essentially having a topside and a bottom side.

The paper carrier is provided on the top and/or on the bottom side with a polymer coating, an antiadhesive layer having been applied at least to one of the two polymer coatings that may be present.

The paper carrier has a density of preferably from 1.12 to 1.2 g/cm³, in particular from 1.14 to 1.16 g/cm³.

Preferably, further, the paper carrier has a basis weight of from 40 to 120 g/m², more preferably from 50 to 110 g/m², with very particular preference from 60 to 100 g/m².

In another advantageous embodiment of the invention the paper carrier is a highly densified glassine paper provided on the top and on the bottom side with a polymer coating, an antiadhesive layer, particularly a silicone coating, having been applied to both polymer coatings.

Polymer coatings used comprise, in particular, polyolefins such as LDPE, HDPE, blends of the two latter polyolefins, such as MDPE, for example, PP or PTE, LDPE is especially advantageous.

The poly-coated sides of the paper carrier of LDPE or HDPE can be produced, moreover, so that they are matt or glossy.

With further preference, the polymer coating is applied at from 5 to 30 g/m², more preferably from 10 to 25 g/m², with very particular preference from 15 to 20 g/m². In the case of polyester in particular the amount applied can also be just 2-3 g/m².

Furthermore, one outstanding embodiment of the invention is provided when silicone, paraffin, Teflon or waxes, for example, are used as antiadhesive layers. It is then possible to e silicon-free release coats, for example, “non silicone” from Rexam, or low-silicone release coats, for example, “Lo ex” from Rexam.

Depending on the particular application of the release material of the invention it is possible to configure the antiadhesive layers on either side of the release material for identical or different release; in other words, to set release properties which differ from one another on either side as well (controlled release).

It is preferred to use solventlessly coated silicone.

More preferably, the solventlessly coated silicone is applied at from 0.8 to 3.7 g/m², more preferably from 1.3 to 3.2 g/m², with very particular preference from 1.8 to 2.8 g/m².

Solventborne systems are also possible, however, with an application rate of in particular from 0.3 to 1 g/m².

This ensures that the lining material with poly coating on either side exhibits

dimensional stability properties (good flatness)

a low thickness with high consistency of thickness (narrow tolerances, more precise diecuts)

and a layer which protects against die-cutting of the paper structure

or that, in the case of single-sided poly coating, the lining material exhibits

a low thickness with high consistency of thickness (narrow tolerances, more precise die cuts) and

a layer which protects against die-cutting of the paper structure.

For applications involving, in particular, critical ambient conditions (high atmospheric humidity and temperature) and large material widths/areas (wide-width lamination), the dimensional stability is met preferably only by means of double sidedly poly-coated kraft papers; for other applications, a single-side poly coating of the kraft liner is sufficient in respect to the requirements in the converting operation.

In both cases, the poly coating not only provides the advantages already described but also protects the paper structure against punch cuts.

The invention finally embraces a lining material with diecuts, obtainable in a converting operation from single or double sidedly adhering diecuts, in which a single or double sided adhesive tape is placed on the lining material and diecuts are punched from said tape, in particular in a kiss-cutting operation.

Especially when the lining material is provided for lining single sided adhesive tapes, it is entirely sufficient if the lining material is provided with an antiadhesive layering on the side that is to be lined.

The lining material with double sidedly adhering diecuts is preferably used for the adhesive bonding of components in electronic apparatuses such as telephones, especially mobile telephones.

In principle, all kinds of single or double sidedly coated adhesive tapes are suitable as base material for the adhesive diecuts, examples of possible carrier material webs for these tapes being, for example, paper, nonwovens, and polymers of a very wide variety of kinds.

With further preference, the adhesive tape has a thickness of from 20 to 320 μm, more preferably from 80 to 260 μm, with very particular preference from 130 to 210 μm.

As adhesives for the adhesive tapes it is possible to use all pressure sensitive adhesives such as are mentioned, for example, in SATAS, Handbook of Pressure Sensitive Adhesive Technology, Third Edition. Particularly suitable adhesives are natural/synthetic rubber based adhesives and acrylate based adhesives, which can be applied from the melt or from solution.

Together with the adhesive product, the release material where used in accordance with the invention provides advantages the like of which could not have been foreseen.

The paper backing used in accordance with the invention, which is antiadhesive, is thin, and in the case of poly coating on both sides is dimensionally stable, is outstandingly suitable for the converting operation of the adhesive diecuts, owing to its advantageous flatness properties and the consistency of thickness.

This makes it possible in particular to use polyolefin/PTE-coated, highly densified glassine papers, which owing to their relatively low thickness can be used with low thickness tolerances preferably in a kiss-cutting operation.

In particular, as a result of the double sidedly poly-coated paper carrier in the lining material, the combination of lining material and adhesive tape possesses great dimensional stability, which is beneficial for the subsequent die-cutting operation.

Illustrated below with reference to a figure and an example is a preferred embodiment of the overall product structure, without intending this to be in any way restrictive. The lining material 3, provided double sidedly with an abhesive coating, is wound up with a double sided adhesive tape 2 to form a roll 1.

When the product is unwound, the adhesive product 2 is on the top side of the antiadhesive release material 3 and is able to pass into the converting equipment (punch).

### EXAMPLE

The adhesive tape provided with the release material in accordance with the claims can be converted by rotary die-cutting to form high quality diecuts. The adhesive tape is unwound together with the release material and, via a back-up roller, is passed through below the rotary die-cutter. Depending on the diecut geometry of the adhesive product on the release material liner, shaped parts are produced which, following stripping and discarding of the remaining matrix, are wound up again. Laminated in during this step is a further, auxiliary liner which lines the open side of the adhesive tape.

The following components are used for a paper carrier of the invention and also for the punched parts:

| | |
|---|---|
| release material liner: | 64 g/m² glassine paper |
| | 15 g/m² LDPE per side |
| | about 1.6 g/m² of a solvent-free |
| | silicone system per side |
| adhesive tape: | 48 μm adhesive tape with a PTE carrier |

In an alternative embodiment, the paper carrier and the punched
parts are as follows:

| | |
|---|---|
| release material liner: | 64 g/m² glassine paper |
| | 15 g/m² LDPE on one side |
| | about 1.6 g/m² of a solvent-free |
| | silicone system per side |
| adhesive tape: | 48 μm adhesive tape with a PTE carrier |

What is claimed is:

1. The use of a paper carrier having a density of from 1.1 to 1.25 g/cm³ as a carrier web
in a lining material for an adhesive tape,
the paper carrier essentially having a top side and a bottom side,
the paper carrier being provided with a polymer coating on the top side and/or on the bottom side, and
an antiadhesive layer having been applied to at least one of the two possible polymer coatings.

2. The use as claimed in claim 1, characterized in that the paper carrier has a density of from 1.12 to 1.2 g/cm³, in particular from 1.14 to 1.16 g/cm³.

3. The use as claimed in claim 1 or 2, characterized in that the paper carrier is a highly densified glassine paper.

4. The use as claimed in any of claims 1 to 3, characterized in that the polymer coating comprises polyolefins such as LDPE, HDPE, mixtures of these two, MDPE for example, PP or PTE.

5. The use as claimed in any of claims 1 to 4, characterized in that the paper carrier is provided on the top side and on the bottom side with a polymer coating and an antiadhesive layer is applied to both polymer coatings.

6. The use as claimed in any of claims 1 to 5, characterized in that silicone-free or low-silicone coats or silicone, paraffin, Teflon or waxes are used as antiadhesive layers.

7. A lining material with diecuts, obtainable in a converting operation for producing single sidedly adhering diecuts, in which a single sided adhesive tape is placed onto the lining materail and diecuts are punched from said tape, in particular in a kiss-cutting operation.

8. A lining material with diecuts, obtainable in a converting operation for producing double sidedly adhering diecuts, in which a double sided adhesive tape is placed onto the lining material and diecuts are punched from said tape, in particular in a kiss-cutting operation.

9. The use of the lining material with diecuts as claimed in claim 8 for adhesively bonding components in telephones, especially mobile telephones.
